(19) United States
(12) Patent Application Publication
(10) Pub. No.: US 2008/0256490 A1
(43) Pub. Date: Oct. 16, 2008

(54) Decision-Based Displays for Medical Information Systems

(75) Inventors: William P. Lord, Fishkill, NY (US); Xinxin Zhu, Croton-On-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,213

(22) PCT Filed: Nov. 6, 2006
(86) PCT No.: PCT/IB06/54128

§ 371 Date: May 9, 2008

Related U.S. Application Data
(60) Provisional application No. 60/735,929, filed on Nov. 10, 2005.

(51) Int. Cl. G06F 3/048

(52) U.S. Cl. 715/835

(57) ABSTRACT

A decision support device incorporates a number of user friendly features. The device is operable to determine context by displaying a flow diagram of a clinical guideline so the clinician can select the current step in treatment (S630). Initial, automatic display of decision support data can be restricted to clinical data only (S420). Data pertinent to the current decision, and therefore automatically selected for display, can be highlighted (S340) when appearing in screens subsequently brought up by the clinician.

The present invention relates to automatic decision support and, more particularly, to the display of decision support data.

Displays in current use for medical workstations typically present data in chronological order and/or by their input source. For example, a patient's record may have nurses notes documenting tests performed, procedures performed, drugs administered, etc. in chronological order, laboratory test results for blood analysis and urinalysis listed by pre-defined groupings, reports from imaging studies, etc.

User-friendly methodology for bringing together, for display, information needed at the point of decision would reduce the time required per decision. In addition, it would help reduce the incidence of medical error, and help towards providing uniform quality of care.

In one aspect, the present invention is directed to a decision support device that includes a user interface showing a flow diagram of a multi-step guideline. The user interface is operable for specifying where, along the guideline, a current stage of service to a service recipient is located. Decision support data to be presented is determined from the specified current stage.

In another aspect of the present invention, a decision support device includes a user interface and a module for identifying, in a multi-step guideline, a current stage of service to a service recipient. A determination is made, from the identified current stage, which information on a screen subsequent to an initial screen and shown on the initial screen is pertinent to making a current decision on service to be rendered. On the subsequent screen, the determined information is highlighted.

In a further aspect, the present invention relates to a medical decision support device including a user interface and a module for identifying a current stage, in a predetermined multi-step guideline, of the medical care of a patient or medical subject. From the identified current stage, a determination is made of clinical information that is in a database, that has been obtained from examination, and/or treatment, of the patient or medical subject and that is pertinent to making a current medical decision on medical care to be rendered to the patient or medical subject. Once the determination has been made, the determined information is displayed simultaneously, automatically and without user intervention. It is displayed on the user interface in a screen template, without adding, for simultaneous display, medical information other than the obtained clinical information.

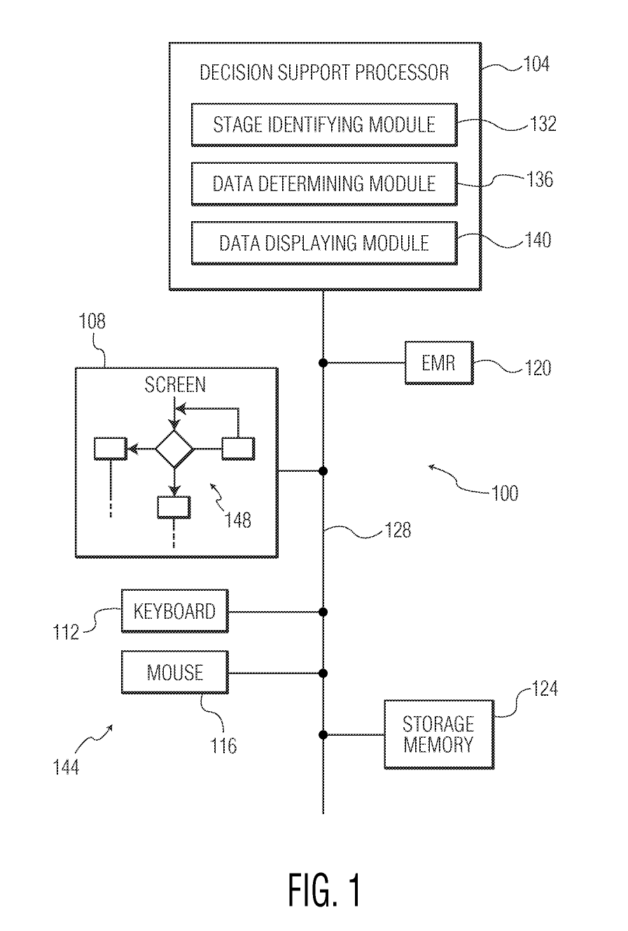

FIG. 1 is a block diagram of an exemplary decision support device according to the present invention;

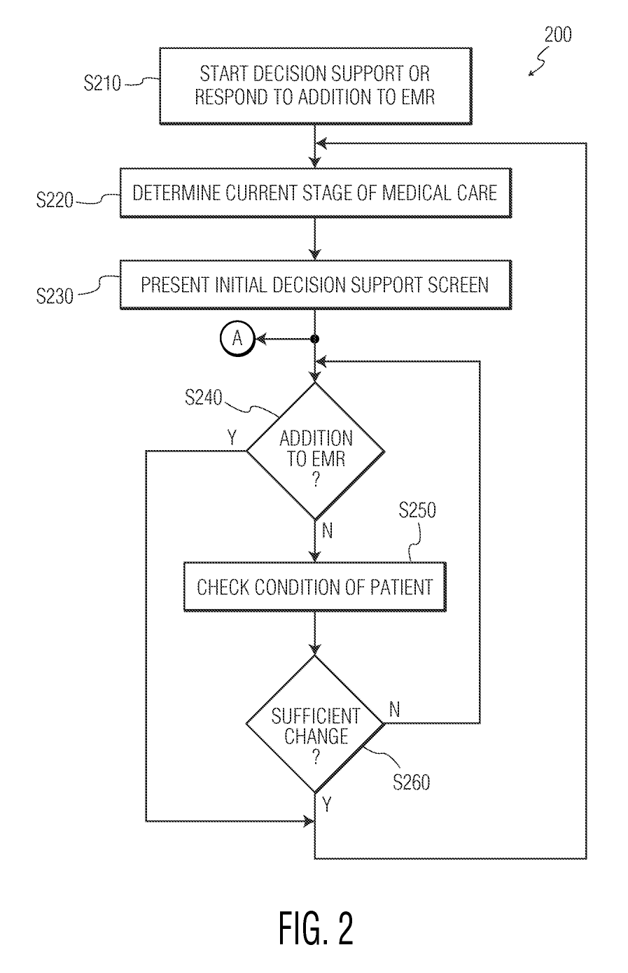

FIG. 2 is flow chart of a tracking process for displaying in synchrony with a current stage of medical care according to the present invention;

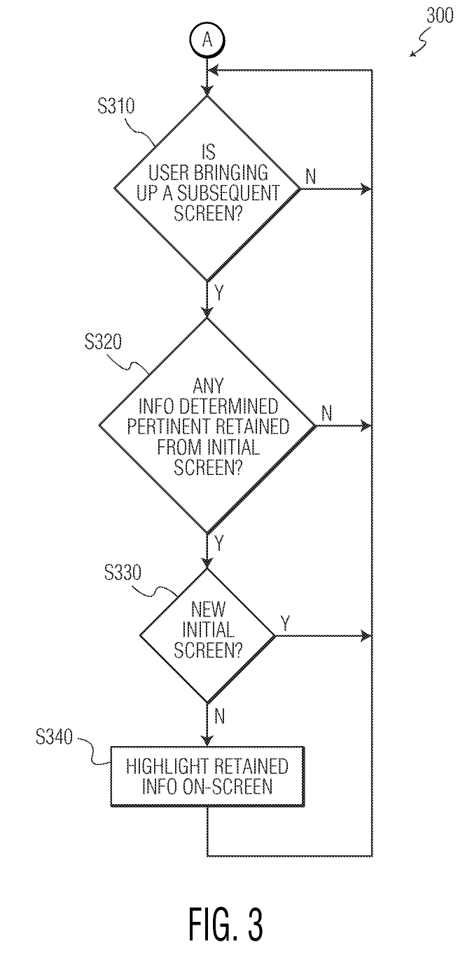

FIG. 3 is a flow chart of a retained-pertinent-information highlighting process for the display of decision support according to the present invention;

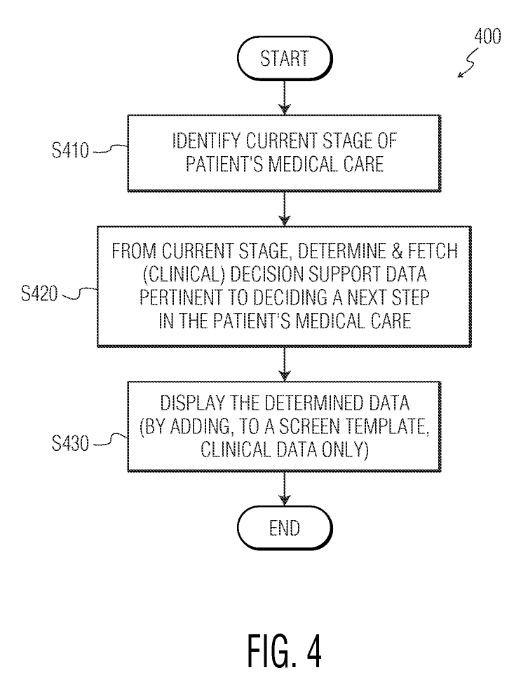

FIG. 4 is a flow chart of a process of decision support, optionally featuring restriction of display to clinical data, according to the present invention;

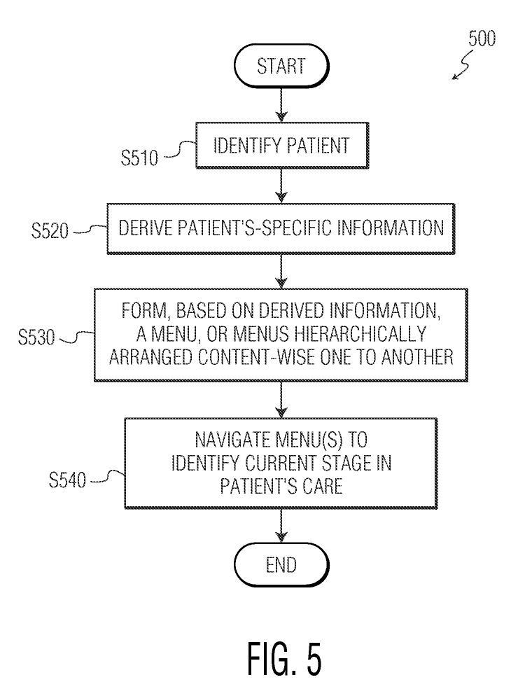

FIG. 5 is a flow chart of a menu-navigation process for determining the current stage of patient care, according to the present invention; and

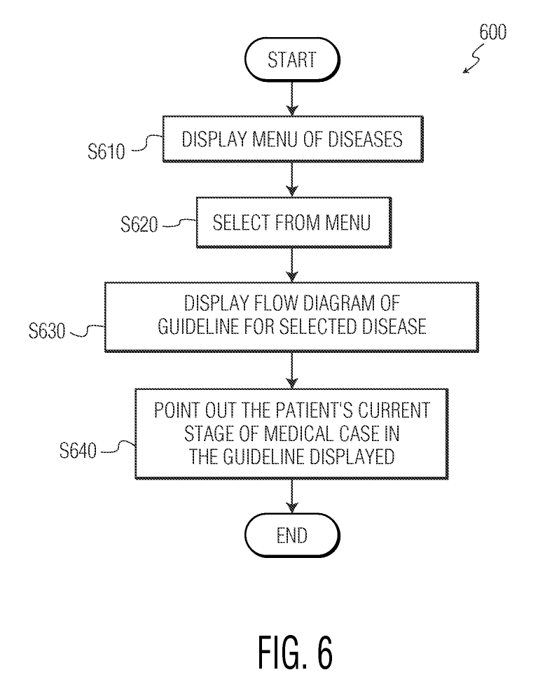

FIG. 6 is a flow chart of a flow-diagram-based process for determining the current stage of patient care, according to the present invention.

FIG. 1 shows an exemplary decision support device 100 according to the present invention. The device 100 includes a processor 104, a display screen 108, a keyboard 112, a mouse 116, an electronic medical record or medical database 120 and a storage memory 124, all mutually connected on a bus 128. The present invention, although principally directed to medical care, can be applied to decision support in administering legal advice, in automotive or computer network troubleshooting, and in other fields.

The processor 104 includes a stage identifying module 132, a data determining module 136 and a data displaying module 140. Each of the modules may be implemented in hardware, software, firmware, or any combination of these.

Although one user interface 144 consisting of the screen 108, keyboard 112 and mouse 116 is shown, a plurality of user interfaces may be provided, and may be identical or differ. One of the user interfaces would typically be located at the hospital bed of an in-patient, and any of the other interfaces might be located at other beds, or at a central monitoring station. The display screen 108 may be a touch screen, and different or additional user-actuatable input devices, such as a track ball, light pen or any other known and suitable means, wired or wireless, may make up the user interface 144. Illustratively, the screen 108 displays a flow chart representation 148 of a particular clinical guideline. The clinical guidelines or “care processes” can also be referred to, among other characterizations, as treatment algorithms, critical pathways, protocols, standing orders or standard operating procedures. The screen 108 is one means for presenting information to the clinician, although the means include aural aspects, holographic display or other techniques.

FIG. 2 shows, by illustrative and non-limitative example, a tracking process 200 for displaying in synchrony with a current stage of medical care according to the present invention. The tracking process 200 is set in motion by the user over the user interface 144 or another of the user interfaces. The user entry that invokes or activates the process 200 may involve a specific screen command. Alternatively, the entry may be any, or a particular addition, to the EMR 120 with respect to the patient whose stage of medical care is to be tracked. The process 200 can also be activated automatically by an addition to the EMR made, for example, by a detected change in condition of the patient (step S210). When the process 200 is started, the stage identifying module 132 determines the current stage of medical care (step S220). The determination can be made by means of user input, as discussed further below, or can be made automatically according to methods set forth in the commonly-assigned, U.S. provisional patent application entitled “Decision Support System with Embedded Clinical Guidelines” to William Lord et al., filed on Nov. 10, 2005, the entire contents and disclosure of which are incorporated by reference as if fully set forth herein. After the data determining module 136 determines which data in the EMR 120 is pertinent to a decision to be made at the current stage, the data displaying module 140 displays an initial decision support screen based on the determination (step S230). At this point, the processor 104 proceeds to monitor the current stage of patient care, and concurrently detects key-ins the user enters to bring up a new screen. The detecting of new screens is detailed in FIG. 3, as described more fully below. Continuing with FIG. 2, any or particular addition to the EMR 120 (step S240) returns the processing to step S220 to decide whether the current stage of care has changed. The decision is made automatically, as mentioned above, or by user intervention as in response to an on-screen query. Any such inquiry can be overridden on the user interface 144, upon arrival at the interface or by user command before arrival. For example, the clinician may be currently at the patient's bedside, and may decide to suspend automatic updating of current stage determination. In the absence of an addition to the EMR 120 in step S240, the stage identifying module 132 checks, based on what it detects regarding the condition of the patient (step S250), whether a predetermined threshold has been exceeded and, if it has been exceeded, likewise returns processing to step S220 (step S260). The detection of a condition may be from the EMR 120, or from a medical sensing device such as a heart monitor.

FIG. 3 provides one example of a retained-pertinent-information highlighting process 300 for the display of decision support according to the present invention. With respect to the current initial decision support screen (step S230), a query is made as to whether the user is bringing up a subsequent screen (step S310). If so, the data displaying module determines whether any information retained from the initial screen is pertinent to the decision to be made (step S320). The retained information may include a screen field retained as is or, for example, a summary of data in the screen field. The screen field or summary may be retained in place or moved to a different location on this subsequent screen. If no new initial screen has been displayed (step S330), the retained pertinent information is highlighted on-screen (step S340). Thus, although a clinician may, for instance, be clicking on an indication of a medical alarm for more details, a pre-selected portion of the pertinent information carried over on-screen is highlighted. The highlighting of information carries over for any subsequently brought up screens, and continues until the currently displayed screen is determined to be a new initial screen presented in step S230.

FIG. 4 depicts an overview of a decision support process 400 that optionally features restriction of display to clinical data, according to the present invention. First, the stage identifying module 132 identifies the current stage of medical care to the patient (step S410), which is the same function performed by step S220. Based on the current stage, the data determining module 136 determines and fetches decision support data that are pertinent to deciding the next step in the patient's medical care (step S420). A number of decision support technologies can be used for this purpose. One possibility is a look-up table that lists all potential items of interest for a given decision. As a more sophisticated implementation, a rules-based system could selectively choose information based on values of other information. Statistical methods such as Bayesian or belief networks could be used to determine what information could be of interest. In one embodiment, the data of interest is restricted to clinical data, i.e., data obtained from examination and/or treatment of the patient or subject, rather than theoretical or experimental data or medical recommendations. The clinical data might include the present vital statistics for the patient, and information obtained in examination, such as family medical history. The data determined data in step S420 is displayed (step S430). In the clinical data embodiment, a screen might typically be made up of a screen template that is filled with the clinical data only. Once the determination is made in step S420, the clinical data to be displayed in step S430 may be displayed simultaneously, automatically and without user intervention. Preferably, the clinician can then choose to display recommendations and/or other information.

FIG. 5 portrays one example of a menu-navigation process 500 executable by the stage identifying module 132 for determining the current stage of patient care in step S410, and optionally in step S220. First, the patient or subject is identified by means of the user interface 144 (step S510). Patient-specific information is then checked, preferably automatically and without user intervention. Such information may include a current condition of the patient derivable from the EMR 120, or any clinical information such as a family history of a certain disease. Based on this information, the stage identifying module 132 forms a menu, or menus hierarchically arranged content-wise, one to another (step S530). The menu or menus are presented on-screen for navigation by the clinician in specifying the current stage in the patient's care (step S540).

FIG. 6 illustrates, as an alternative or supplement to the menu-navigation process shown in FIG. 5, a flow-diagram-based process 600 for determining the current stage of patient care. A menu of diseases is displayed (step S610), which may be as a result of selection from a previously-displayed menu. Selection of a disease is made from the menu (step S620). At this point, the clinician may or may not yet have operated the decision support device 100 to identify the patient or subject. A flow diagram or flow chart 148 of the guideline for the selected disease is displayed (step S630). The clinician now can point out on the displayed guideline 148 the patient's current stage or step in medical care, by means of a touch screen, light pen, cursor or any other functionality of the user interface 144 (step S640).

As has been demonstrated above, user-friendly features such as displayed flow diagrams, highlighting pertinent information on subsequent screens, and restriction of display to clinical data afford the potential to urge widespread acceptance of automated medical decision support.

While there have shown and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it should be recognized that structures and/or elements and/or method steps shown and/or described in connection with any disclosed form or embodiment of the invention may be incorporated in any other disclosed or described or suggested form or embodiment as a general matter of design choice.

1. A decision support device comprising:
a user interface (108) that shows a flow diagram (148) of a multi-step guideline and is operable for specifying where, along said guideline, a current stage of service to a service recipient is located (S220, S410); and
a module for determining, from the specified current stage, decision support data to be presented (S430).

2. The device of claim 1, wherein the determining module is further configured for, responsive to said specifying, deriving automatically and without user intervention, said data from a database (120), said data being pertinent to making a current decision on service to be rendered to said recipient.

3. The device of claim 1, further configured for, upon said determining module (136) determining said data:
fetching said data (S420); and
presenting said data simultaneously, automatically and without user intervention (S430).

4. The device of claim 1, configured such that the showing is in response to user selection from a menu of diseases (S610, S620).

5. A decision support device comprising:
a user interface (108);
a module for identifying, in a multi-step guideline, a current stage of service to a service recipient (132); and
a module for determining (136), from the identified current stage, which information that is on a screen subsequent to an initial screen and that is shown on said initial screen is pertinent to making a current decision on service to be rendered, and for highlighting (S340), on said subsequent screen, the determined information.

6. The device of claim 5, wherein said initial screen is an initial screen of the identified current stage (S230), said device being configured for said highlighting, before identification of a new current stage (S330), on all screens brought up by the user on said interface subsequently to said initial screen.

7. The device of claim 6, wherein said module for identifying is configured for said identifying of said new current stage automatically in response to a database reflecting sufficient change in condition for said recipient and/or in response to addition to said database with respect to said recipient (S240, S260), a new initial screen being brought up on said user interface automatically in the event of said identifying of a new current stage.

8. The device of claim 5, wherein said identifying is performed from an electronic medical record of service to said service recipient, said service is medical care, and said recipient is a patient or medical subject (120, S410).

9. The device of claim 5, wherein said service to be rendered is service to said recipient and said determining is from a database (120), said device being further configured for determining, from the identified current stage, data, in a database, that are pertinent to making a current decision on service to be rendered to said recipient, and for, once said determining determines said data, simultaneously presenting, automatically and without user intervention, said data on said initial screen on said user interface (S230), said device further being configured for said determining of said information, automatically in response to a user bringing up on said interface the subsequent screen (S3 10).

10. A medical decision support device comprising:
a user interface (108);
a module for identifying, in a predetermined multi-step guideline, a current stage of medical care of a patient or medical subject (132); and
a module for determining (136), from the identified current stage, clinical information that is in a database, that has been obtained from examination, and/or treatment, of said patient or medical subject and that is pertinent to making a current medical decision on medical care to be rendered to said patient or medical subject, and for, once the determination is made, simultaneously displaying the determined information automatically and without user intervention, on a screen template on said user interface, without adding, for simultaneous display, medical information other than the obtained clinical information (S430).

11. The device of claim 10, wherein said user interface includes, for specifying where said current stage is located along a multi-step guideline, a menu, or a plurality of menus hierarchically arranged by content (S530), said device being configured for deriving, from said electronic medical record, information specific to said patient or medical subject, and for forming the at least one menu based on the derived information.

12. A computer-implemented medical decision support method comprising:
identifying a current stage, in a predetermined multi-step guideline, of medical care of a patient or medical subject (S410);
determining, from the identified current stage, clinical information that is in a database, that has been obtained from examination, and/or treatment, of said patient or medical subject and that is pertinent to making a current medical decision on medical care to be rendered to said patient or medical subject (S420); and,
once the determination is made, simultaneously displaying the determined information automatically and without user intervention, in a screen template on a user interface, without adding, for simultaneous display, medical information other than the obtained clinical information (S430).

13. The method of claim 12, wherein said identifying comprises operating said user interface to specify where said current stage is located along said multi-step guideline (S640).

14. The method of claim 13, wherein said operating includes operating a menu on a screen (S610).

15. The method of claim 14, further comprising:
deriving, from said electronic medical record, a current medical condition of said patient or medical subject (S520); and
forming, based on the derived condition, at least one menu of a plurality of menus hierarchically arranged by content (S530);
wherein said operating includes operating ones of the plural menus, including said at least one menu.

16. The method of claim 13, wherein the identifying includes showing, for the specifying, a flow diagram of said multi-step guideline (S630).

17. A computer program product comprising a computer readable medium in which is embedded a program that includes instructions executable by a processor to perform the method of claim 12 (124).

18. A computer-implemented decision support method comprising:
identifying a current stage of service, in a predetermined multi-step guideline, to a service recipient (S220); and
determining, from the identified current stage, which information that is on a screen subsequent (S3 10) to an initial screen and that is shown on said initial screen is pertinent to making a current decision on service to be rendered, and for highlighting, on said subsequent screen, the determined information.

19. The method of claim 18, wherein said initial screen is an initial screen of the identified current stage, the automatic highlighting being performed (S340), before identification of a new current stage, on all screens brought up by the user on said interface subsequently to said initial screen.

20. The method of claim 18, wherein said identifying is performed from an electronic medical record (120) of service to said service recipient, said service is medical care, and said recipient is a patient or medical subject (S410).

21. A computer program product comprising a computer readable medium in which is embedded a program that includes instructions executable by a processor to perform the method of claim 18 (124).
